(19) United States
(12) Patent Application Publication
(10) Pub. No.: US 2025/0252520 A1
(43) Pub. Date: Aug. 7, 2025

(54) EDUCATION SUPPORT APPARATUS, EDUCATION SUPPORT METHOD, AND NON-TRANSITORY COMPUTER-READABLE MEDIUM

(71) Applicant: NEC Corporation, Tokyo (JP)

(72) Inventors: Shinnosuke Nishimoto, Tokyo (JP); Kenichi Ueda, Tokyo (JP); Yoshikazu Arai, Tokyo (JP); Yuki Kobayashi, Tokyo (JP)

(73) Assignee: NEC Corporation, Tokyo (JP)

(21) Appl. No.: 19/001,656

(22) Filed: Dec. 26, 2024

(30) Foreign Application Priority Data
Feb. 2, 2024 (JP) 2024-015071

(51) Int. Cl. G06Q 50/20; G06F 40/279; G06F 40/40

(52) U.S. Cl. CPC G06Q 50/2057; G06F 40/279; G06F 40/40

(57) ABSTRACT

In the education support apparatus of the present disclosure, an acquisition unit acquires information of the user and information of a target of the user, an attribute analysis unit analyzes an attribute of the user and a request attribute of the target of the user by using a language model, from the information of the user and the information of the target of the user, an attribute gap analysis unit analyzes a difference in an attribute between the attribute of the user and the request attribute of the target of the user, and an educational content proposal unit generates at least one educational content for the first target for causing the user to add an attribute, based on the difference in the attribute, and proposes the generated educational content to the user.

### INCORPORATION BY REFERENCE

This application is based upon and claims the benefit of priority from Japanese patent application No. 2024-015071, filed on Feb. 2, 2024, the disclosure of which is incorporated herein in its entirety by reference.

### TECHNICAL FIELD

The present disclosure relates to an education support apparatus, an education support method, and a program.

### BACKGROUND ART

Japanese Patent No. 7299663 discloses a technique for matching a job seeker with a job offerer by collating an attribute of the job seeker with an attribute of the job seeker requested by the job offerer to the job seeker.

### SUMMARY

A user (e.g., a job seeker) may desire a target (e.g., a job offerer) of the user that could not be matched. However, in order for a user to easily fulfill his/her desire, it is necessary to support the user with education according to a request attribute of the target of the user. However, in Japanese Patent No. 7299663, supporting of the education has not been made.

In view of such a problem, an example object of the present disclosure is to provide an education support apparatus, an education support method, and a program that are capable of supporting a user with education according to a request attribute of a target of a user.

In a first example aspect, an education support apparatus according to the present disclosure includes:
an acquisition unit configured to acquire information of a user and information of a first target of the user;
an attribute analysis unit configured to analyze an attribute of the user and a request attribute of the first target of the user by using a language model, from the information of the user and the information of the first target of the user;
an attribute gap analysis unit configured to analyze a difference in an attribute between the attribute of the user and the request attribute of the first target of the user; and
an educational content proposal unit configured to generate at least one educational content for the first target for causing the user to add an attribute, based on the difference in the attribute, and propose the generated educational content to the user.

In a second example aspect, an education support method according to the present disclosure includes:
acquiring information of a user and information of a first target of the user;
analyzing an attribute of the user and a request attribute of the first target of the user by using a language model, from the information of the user and the information of the first target of the user;
analyzing a difference in an attribute between the attribute of the user and the request attribute of the first target of the user; and
generating at least one educational content for the first target for causing the user to add an attribute, based on the difference in the attribute, and proposing the generated educational content to the user.

In a third example embodiment, a program according to the present disclosure causes a computer to execute processing of:
acquiring information of a user and information of a first target of the user;
analyzing an attribute of the user and a request attribute of the first target of the user by using a language model, from the information of the user and the information of the first target of the user;
analyzing a difference in an attribute between the attribute of the user and the request attribute of the first target of the user; and
generating at least one educational content for the first target for causing the user to add an attribute, based on the difference in the attribute, and proposing the generated educational content to the user.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a block diagram illustrating one example of an education support apparatus 10 according to the present example embodiment;

FIG. 2 is a block diagram illustrating one example of an education support apparatus 20 according to the present example embodiment;

FIG. 3 is a flowchart illustrating one example of operation of the education support apparatus 20 according to the example embodiment;

FIG. 4 is a flowchart illustrating one example of processing in step S103 of the education support apparatus 20 according to the present example embodiment;

FIG. 5 is a diagram illustrating one example of an attribute gap between an attribute of a job seeker and a request attribute of a job offerer Y1 that are analyzed by the education support apparatus 20 according to the present example embodiment;

FIG. 6 is a diagram illustrating one example of an educational content proposal screen displayed on a job seeker terminal 100 by the education support apparatus 20 according to the present example embodiment;

FIG. 7 is a diagram illustrating one example of a feedback screen displayed on the job seeker terminal 100 by the education support apparatus 20 according to the present example embodiment;

FIG. 8 is a flowchart illustrating one example of operation of an education support apparatus 30 according to the present example embodiment;

FIG. 9 is a diagram illustrating one example of a feedback screen displayed on the job seeker terminal 100 by the education support apparatus 30 according to the present example embodiment;

FIG. 10 is a diagram illustrating one example of a training plan to be proposed by an education support apparatus 40 according to the present example embodiment; and

FIG. 11 is a block diagram illustrating one example of a hardware configuration of a computer 500 according to the present example embodiment.

### EXAMPLE EMBODIMENT

Hereinafter, example embodiments of the present disclosure will be described in detail with reference to the drawings. In each of the drawings, the same or corresponding elements are denoted by the same reference signs, and redundant descriptions are omitted as necessary for clarity of description.

### First Example Embodiment

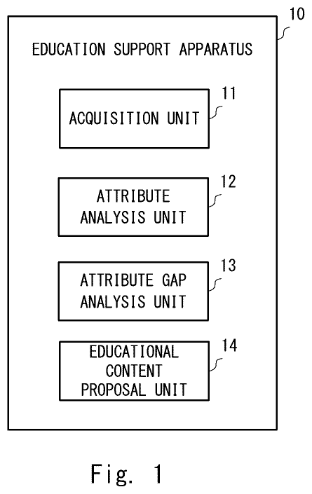

First, a configuration of an education support apparatus 10 according to a first example embodiment will be described with reference to FIG. 1.

FIG. 1 is a block diagram illustrating one example of the configuration of the education support apparatus 10 according to the present example embodiment. As illustrated in FIG. 1, the education support apparatus 10 includes an acquisition unit 11, an attribute analysis unit 12, an attribute gap analysis unit 13, and an educational content proposal unit 14.

The acquisition unit 11 acquires information of a user and information of a target of the user.

The attribute analysis unit 12 analyzes an attribute of the user and a request attribute of the target of the user by using a language model, from the information of the user and the information of the target of the user.

The attribute gap analysis unit 13 analyzes a difference in an attribute between the attribute of the user and the request attribute of the target of the user.

The educational content proposal unit 14 generates at least one educational content for the target for causing the user to add an attribute, based on the difference in the attribute, and proposes the generated educational content to the user.

Therefore, the education support apparatus 10 according to the first example embodiment can support a user with education according to a request attribute of a target of the user. Even in a case where a user desires a target of the user that could not match due to not satisfying the request attribute, the education support apparatus 10 can easily fulfill the desire by receiving the support of education.

### Second Example Embodiment

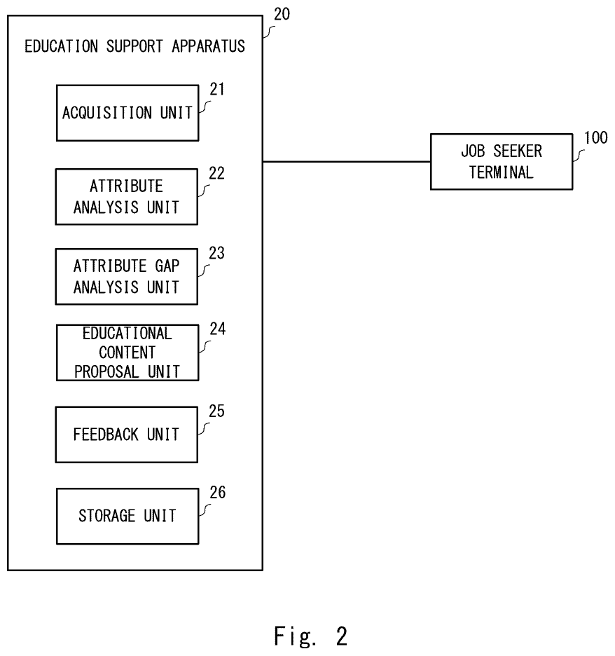

Subsequently, a configuration of an education support apparatus 20 according to a second example embodiment will be described with reference to FIG. 2.

FIG. 2 is a block diagram illustrating one example of the configuration of the education support apparatus 20 according to the second example embodiment.

As illustrated in FIG. 2, the education support apparatus 20 is a specific example of the education support apparatus 10 according to the first example embodiment. A “user” of the first example embodiment is described as a “job seeker” in the second example embodiment, and a “target of a user” is described as a “job offerer”. Note that, the “user” and the “target of the user” are not limited to the above-described one example. For example, the “user” may be an “examinee”, and the “target of the user” may be a “university”. Further, the “user” may be an “employee”, and the “target of the user” may be an “employer”.

The education support apparatus 20 is, for example, a server. The education support apparatus 20 is an apparatus that supports a job seeker with education for a job offerer desired by the job seeker. The education support apparatus 20 communicates with a job seeker terminal 100 being a terminal used by a job seeker. The job seeker terminal 100 is, for example, a terminal such as a smart phone, a tablet, or a personal computer (PC). The job seeker terminal 100 may install an application dedicated to the education support apparatus 20.

Specifically, the education support apparatus 20 includes an acquisition unit 21, an attribute analysis unit 22, an attribute gap analysis unit 23, an educational content proposal unit 24, a feedback unit 25, and a storage unit 26. Note that, the acquisition unit 21, the attribute analysis unit 22, the attribute gap analysis unit 23, and the educational content proposal unit 24 correspond to the acquisition unit 11, the attribute analysis unit 12, the attribute gap analysis unit 13, and the educational content proposal unit 14 of the first example embodiment, respectively.

The acquisition unit 21 acquires information of a job seeker (hereinafter, job seeking information). Further, the acquisition unit 21 acquires information (hereinafter, job offering information) of a job offerer Y1 being selected by a job seeker.

The attribute analysis unit 22 analyzes an attribute of a job seeker and an attribute (hereinafter, a request attribute) requested by a job offerer by using a language model, from the job seeking information of the job seeker and the job offering information of the job offerer.

Herein, a definition of an attribute will be described. The attribute indicates a skill, knowledge, an experience, and the like of a job seeker. As one example, the attribute is classified into three categories: a technical skill (a hard skill), a soft skill, and a business skill. The technical skill is specialized knowledge or skill required for a specific job type or work. For example, the technical skill is programming, a data analysis, machine operation, and the like. The soft skill is a skill related to an interpersonal relationship and a way to proceed with work. For example, the soft skill is communication ability, teamwork, problem solving ability, and the like. The business skill is basic business knowledge and skill required for execution of business. For example, the business skill is project management, marketing, financial knowledge, and the like.

Further, the definition of a language model will also be described. The language model is a model that trains a relationship between words in a sentence, and is a machine learning model that generates, from a target character string, a related character string related to the target character string. By using a language model in which various contexts or sentences are trained, it is possible to generate a related character string having a valid content related to a target character string.

For example, a case where the language model is used in question answering will be described. The language model accepts an input of a question being “what kind of country is Japan?” as a target character string. The language model generates a character string such as “Japan is an island country in the northern hemisphere . . . ” as an answer to the question. Note that, a method of training the language model is not particularly limited, but may be, as one example, one trained in such a way as to output at least one sentence including an input character string.

To give a specific example, the language model is generative pre-trained transformer (GPT) outputting a sentence including a character string input by predicting a character string having a higher probability following the input character string. In addition, for example, text-to-text transfer transformer (T5), bidirectional encoder representations from transformers (BERT), a robustly optimized BERT approach (RoBERTa), efficiently learning an encoder that classifies token replacements accurately (ELECTRA), and the like are also the language models.

Further, a character string generated by the language model is not limited to a natural language. For example, the language model may output an artificial language (a program source code, or the like) with respect to a character string input in the natural language. For example, the language model accepts an input of a question being “how to acquire data including a specific character string from a database?” as a target character string. The language model may output a program source code for performing database processing. Alternatively, the language model may output the natural language associated to a character string being input in the artificial language. Further, a content generated by the language model is not limited to a character string. The language model may generate, for example, image data, moving image data, audio data, or another data format associated to the input character string.

The attribute gap analysis unit 23 analyzes a difference in an attribute (hereinafter, an attribute gap) between the attribute of a job seeker and the request attribute of the job offerer Y1. The attribute gap is represented by at least one of a cosine similarity degree, a Euclidean distance, and a similarity degree according to a pre-trained language model including bidirectional encoder representations from transformers (BERT).

The educational content proposal unit 24 generates at least one educational content for the job offerer Y1, based on the attribute gap between the attribute of a job seeker and the request attribute of the job offerer Y1. Specifically, the educational content proposal unit 24 generates at least one educational content for the job offerer Y1 in such a way as to reduce the attribute gap between the attribute of the job seeker and the request attribute of the job offerer Y1. Then, the educational content proposal unit 24 proposes the generated educational content to the job seeker.

The feedback unit 25 provides a job seeker with feedback information including information indicating how the attribute gap between the attribute of the job seeker and the request attribute of the job offerer Y1 changes before and after attendance of the at least one educational content. For example, the feedback unit 25 provides the job seeker terminal 100 with feedback information.

The storage unit 26 stores various types of information. The storage unit 26 stores the job seeking information of a job seeker and the job offering information of the job offerer Y1 that are acquired, the attribute of the job seeker, the request attribute of the job offerer Y1, and the attribute gap that are analyzed, the educational content and the feedback information that are generated, and the like.

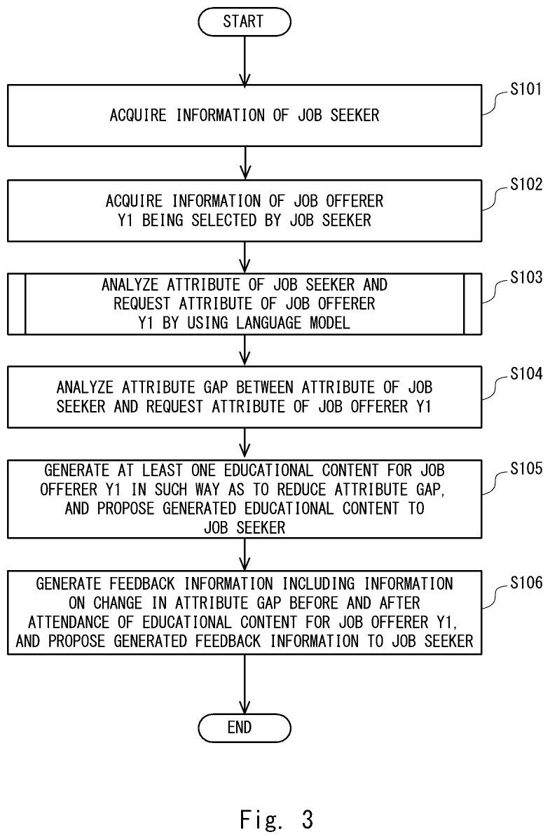

Subsequently, operation of the education support apparatus 20 according to the second example embodiment will be described with reference to FIGS. 3 to 7.

FIG. 3 is a flowchart illustrating one example of operation of the education support apparatus 20 according to the example embodiment.

As illustrated in FIG. 3, first, in step S101, the acquisition unit 21 of the education support apparatus 20 acquires job seeking information of a job seeker.

The job seeking information of a job seeker includes information such as a name, a date of birth, gender, an educational background, a job history, a reason for leave, self-PR, a job seeking state, a desired job type, a desired work place, a desired annual income, a qualification, and a language skill. The acquisition unit 21 accepts an input of the job seeking information by the job seeker from the job seeker terminal 100.

Next, in step S102, the acquisition unit 21 acquires job offering information of the job offerer Y1 being selected by the job seeker.

The job offering information of a job offerer includes basic information (e.g., a company name, a job type, a work place, and a salary), a skill and a requirement (e.g., an essential skill, a desirable skill, a necessary experience and qualification), a job content (e.g., a main business content, a technique and tool to be used), and others (e.g., a regular employee, a contract employee, a part-time employee, and the like, welfare, a corporate culture, and a mission). The acquisition unit 21 collects the job offering information of the job offerer from the Internet. For the collection, a web crawling technique, or an API, a DB, and the like that provides the job offering information are used. Specifically, in a case where the web crawling technique is used, the acquisition unit 21 automatically collects the job offering information from a specific job offering information site or a carrier page of a company by using a Python library (e.g., Beautiful Soup or Scrapy). Further, in a case where a major job offering information providing service or an employment placement service provides an API or a DB, the acquisition unit 21 may collect the job offering information by using the API or the DB. Note that, since it may be difficult to automatically collect some pieces of the job offering information, the acquisition unit 21 may manually accepts an input of the job offering information by a job offerer from a terminal used by the job offerer.

Next, in step S103, the attribute analysis unit 22 analyzes an attribute of the job seeker and a request attribute of the job offerer Y1 by using a language model, from the job seeking information of the job seeker and the job offering information of the job offerer Y1.

The attribute indicates a skill, knowledge, an experience, and the like of a job seeker. As one example, the attribute is classified into three categories: a technical skill (a hard skill), a soft skill, and a business skill. The technical skill is specialized knowledge or skill required for a specific job type or work. For example, the technical skill is programming, a data analysis, machine operation, and the like. The soft skill is a skill related to an interpersonal relationship and a way to proceed with work. For example, the soft skill is communication ability, teamwork, problem solving ability, and the like. The business skill is basic business knowledge and skill required for execution of business. For example, the business skill is project management, marketing, financial knowledge, and the like.

Further, the required skill varies by job type and industry. For example, an engineer is required to have knowledge of a programming language, system design ability, knowledge and ability related to database management, knowledge and ability related to debugging and testing, an experience in using a version management system, and an experience in agile development. Specifically, the knowledge of the programming language is deep knowledge related to a specific language, such as Java, Python, and C++. Further, the system design ability is ability to understand and plan a design of the whole system and cooperation between modules. The knowledge and ability related to the database management are knowledge of a database language such as SQL, and ability to manage and operate data. The knowledge and ability related to debugging and testing are ability to find and fix a software bug, and knowledge of a testing method such as test drive development. The experience in using a version management system is an experience in using a version management tool such as Git. The experience in agile development is an experience in project management based on an agile development methodology such as a scram and a kanban.

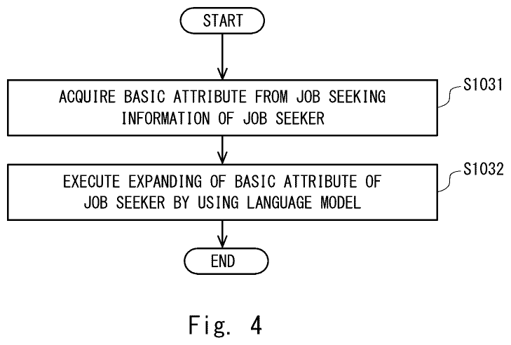

In the processing of step S103, the attribute analysis unit 22 analyzes the attribute of the job seeker by using the language model from the job seeking information of the job seeker, for example, by processing of steps S1031 to S1032 illustrated in FIG. 4. Note that, the attribute analysis unit 22 analyzes the request attribute of the job offerer Y1 by using the language model from the job offering information of the job offerer Y1 in a similar manner to the attribute of the job seeker.

FIG. 4 is a flowchart illustrating one example of the processing in step S103 of the education support apparatus 20 according to the present example embodiment.

As illustrated in FIG. 4, first, in step S1031, the attribute analysis unit 22 acquires a basic attribute of the job seeker included in the job seeking information of the job seeker. For example, the basic attribute is “‘name’:‘tanaka’, ‘occupation’:‘engineer’”.

Next, in step S1032, the attribute analysis unit 22 expands the basic attribute by using the language model. Specifically, the attribute analysis unit 22 throws the acquired occupation of the job seeker into the language model as a query. The query is “what is the attribute of a user associated with {‘occupation’:‘engineer’}?”. Next, the attribute analysis unit 22 receives a relevant attribute with respect to a prompt from the language model in a text format. The received data are “‘programming’, ‘software development’, ‘system design’”. In other words, the attribute analysis unit 22 expands, by using the language model, the basic attribute of the job seeker being “‘occupation’:‘engineer’” to the attribute being “‘programming’, ‘software development’, ‘system design’”.

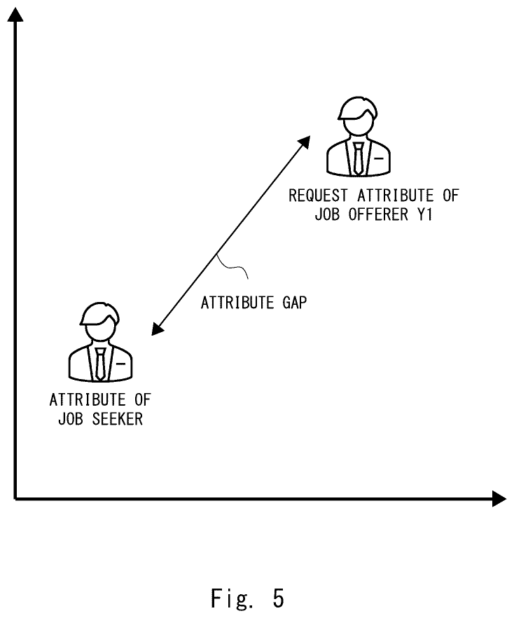

Returning back to the description in FIG. 3. Next, in step S104, the attribute gap analysis unit 23 analyzes an attribute gap between the attribute of the job seeker and the request attribute of the job offerer Y1. An analysis result of the attribute gap is illustrated in FIG. 5.

FIG. 5 is a diagram illustrating one example of an attribute gap between an attribute of a job seeker and a request attribute of the job offerer Y1 that are analyzed by the education support apparatus 20 according to the present example embodiment. As illustrated in FIG. 5, the attribute gap is represented by at least one of a cosine similarity degree, a Euclidean distance, and a similarity degree using a pre-trained language model such as BERT. Specifically, the attribute gap analysis unit 23 expresses a text of the attribute as a vector, and calculates the cosine similarity degree therebetween. This method is often used in a training method referred to as word2vec and another embedding particularly. Further, the attribute gap analysis unit 23 expresses the text of the attribute as a vector, and calculates the Euclidean distance. This method is useful in a case where an embedding vector of the text reflects a semantic distance in Euclidean space. Further, the attribute gap analysis unit 23 embeds the text of the attribute by a pre-trained language model such as BERT, and calculates the similarity degree between the vectors.

Returning back to the description in FIG. 3. Next, in step S105, the educational content proposal unit 24 generates at least one educational content for the job offerer Y1 in such a way as to reduce the attribute gap between the attribute of the job seeker and the request attribute of the job offerer Y1, and proposes the generated educational content to the job seeker. Herein, the educational content is a content for adding a predetermined attribute to a job seeker.

For example, the educational content proposal unit 24 proposes educational contents A, B, and C to the job seeker as an educational content for the job offerer Y1. Herein, each of the educational contents A, B, and C is generated in such a way that there is no attribute gap between the attribute of the job seeker after attendance of all the contents and the request attribute of the job offerer Y1. It is assumed that a main factor of the gap of the attribute between the attribute of the job seeker and the request attribute of the job offerer Y1 is an attribute #1 to an attribute #6. The educational content A is generated as a content for causing the attribute #1, the attribute #2, and the attribute #3 to be added to the attribute of the job seeker after attendance of the educational content A by the job seeker. The educational content B is generated as a content for causing the attribute #4 and the attribute #5 to be added to the attribute of the job seeker after attendance of the educational content B by the job seeker. The educational content C is generated as a content for causing the attribute #6 to be added to the attribute of the job seeker after attendance of the educational content C by the job seeker. Note that, the educational content proposal unit 24 may generate the educational content in such a way that there is no attribute gap between the attribute of the job seeker and the request attribute of the job offerer Y1 by attending a single educational content (e.g., only the educational content A).

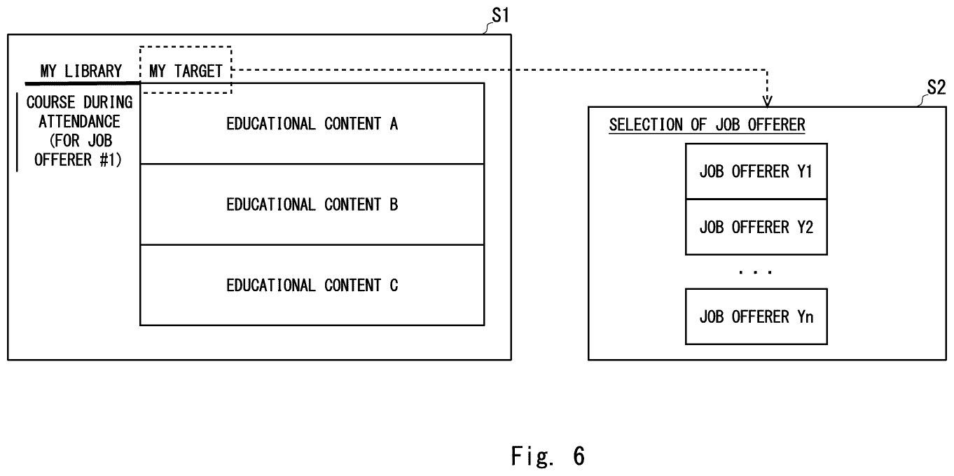

Further, the educational content proposal unit 24 causes the job seeker terminal 100 to display the educational content on an educational content proposal screen illustrated in FIG. 6. FIG. 6 is a diagram illustrating one example of an educational content proposal screen displayed on the job seeker terminal 100 by the education support apparatus 20 according to the present example embodiment. As illustrated in FIG. 6, a screen S1 is a proposal screen of an educational content. When the job seeker presses “my library” on the screen S1, the educational contents A, B, and C for the job offerer Y1 are displayed on the job seeker terminal 100. A screen S2 is a job offerer selection screen for selecting a job offerer targeted by the job seeker from among job offerers Y1 to Yn. When the job seeker presses “my target” on the screen S1, the screen S2 is displayed on the job seeker terminal 100. By doing so, the educational content proposal unit 24 can propose, to the job seeker, an optimum educational content for the job offerer Yn being selected by the job seeker. The job seeker can train effectively toward the job offerer Yn being a target of the job seeker.

Note that, in step S105, the educational content proposal unit 24 may generate the educational content that does not change the attribute gap between the attribute of the job seeker and the request attribute of the job offerer Y1 or increases the attribute gap, without limitation of the educational content that reduces the attribute gap.

Next, in step S106, the feedback unit 25 provides the job seeker with feedback information including information on a change in the attribute gap before and after attendance of the educational content for the job offerer Y1. In other words, the feedback information includes information indicating how the attribute gap between the attribute of the job seeker before attendance of each educational content and the request attribute of the job offerer Y1 has changed compared to the attribute gap between the attribute of the job seeker after attendance of each educational content and the request attribute of the job offerer Y1.

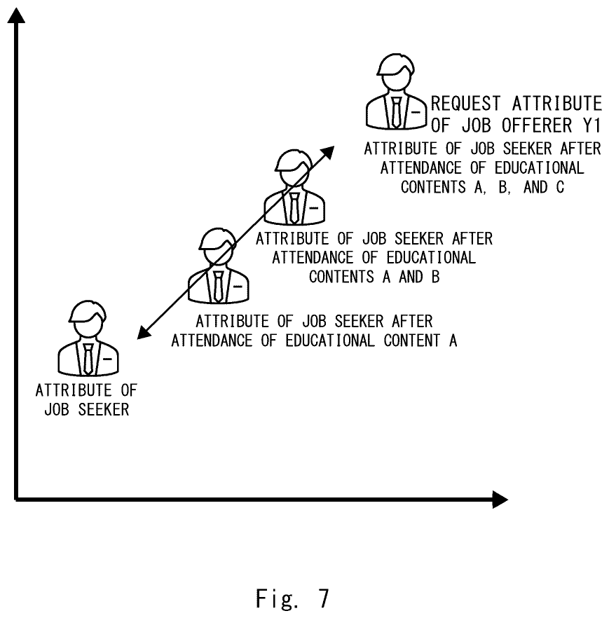

For example, the feedback unit 25 causes the job seeker terminal 100 to display a screen (feedback screen) including the feedback information illustrated in FIG. 7. FIG. 7 is a diagram illustrating one example of a feedback screen displayed on the job seeker terminal 100 by the education support apparatus 20 according to the present example embodiment. As illustrated in FIG. 7, the attribute of the job seeker, the request attribute of the job offerer Y1 being selected by the job seeker, and the attribute gap therebetween are displayed on the feedback screen. Further, on the feedback screen, the attribute of the job seeker after attendance of the educational content A, the attribute of the job seeker after attendance of the educational contents A and B, and the attribute of the job seeker after attendance of the educational contents A, B, and C are displayed. Herein, the attribute of the job seeker after attendance of the educational contents A, B, and C matches with the request attribute of the job offerer Y1. From such feedback information, the job seeker can know, by the feedback information, how the attribute gap between the attribute of the job seeker him/herself and the request attribute of the job offerer Y1 being the target reduces in a process of attending the educational contents A, B, and C. The job seeker is more likely to plan to achieve the target. Further, the job seeker can realize the own growth. Furthermore, the job seeker can determine which educational content should be attended priority in order to achieve the target.

As described above, the education support apparatus 20 according to the second example embodiment can support a job seeker with education according to a request attribute of a job offerer being a user. Even in a case where a job seeker desires a job offerer who could not match due to not satisfying the request attribute, the education support apparatus 20 can easily fulfill the desire by receiving the support of education. For example, a job seeker is more likely to be employed to a desired job offerer by receiving the support of education.

Further, in order to adapt to a rapidly changing market environment, a present company is required to update a skill set of an employee in the company and perform re-training (reskilling). For this reason, in-house training or education for an adult is emphasized. As described above, in the education support apparatus 20, a “job seeker” can be used as an “employee”, and a “job offerer” can be used as an “employer”. In this case, the education support apparatus 20 can perform effective supporting on education such as adding an attribute required by an employer to an employee during in-house training or education for an adult.

Note that, the education support apparatus 20 according to the second example embodiment does not need to include the attribute analysis unit 22 that analyzes an attribute of a job seeker and a request attribute of a job offerer by using a language model, from job seeking information of the job seeker and job offering information of the job offerer that are acquired by the acquisition unit 21.

In this case, the acquisition unit 21 of the education support apparatus 20 acquires the job seeking information of the job seeker and the job offering information of the job offerer Y1. The attribute gap analysis unit 23 analyzes an attribute gap between the attribute of the job seeker included in the job seeking information and the request attribute of the job offerer Y1 included in the job offering information. The educational content proposal unit 24 generates at least one educational content for the job offerer Y1 for causing the job seeker to add an attribute, based on the attribute gap, and proposes the generated educational content to the job seeker.

As an operation of the education support apparatus 20, as illustrated in FIG. 3, the education support apparatus 20 does not perform the processing of step S103 described above. Instead of that, in the processing of step S104 described above, the attribute gap analysis unit 23 analyzes the attribute gap between the attribute of the job seeker included in information of the job seeker and the request attribute of the job offerer Y1 included in information of the job offerer.

By doing so, for example, in the job seeking information of the job seeker and the job offering information of the job offerer, it is possible to efficiently perform processing in a case where there is no attribute expansion by the language model or the like.

Moreover, the job offering information of the job offerer may be “ideal job offering information” being set by the job seeker. For example, the acquisition unit 21 of the education support apparatus 20 acquires the ideal job offering information by a manual input of the job seeker from the job seeker terminal 100. By doing so, the job seeker can add an ideal attribute by the educational content.

### Third Example Embodiment

Subsequently, a configuration of an education support apparatus 30 according to a third example embodiment will be described.

The education support apparatus 30 further includes a configuration capable of supporting education in such a way as to give flexibility to an option of a target of a job seeker being a user. The education support apparatus 30 basically includes a configuration similar to the education support apparatus 20 according to the second example embodiment (see FIG. 2). However, the education support apparatus 30 further includes the following configuration.

An educational content proposal unit 24 of the education support apparatus 30 proposes, to a job seeker, a job offerer Y2 being different from a job offerer Y1 and satisfying a predetermined condition. The predetermined condition is that the job offerer Y2 has a request attribute in which an attribute gap between an attribute of a job seeker and the request attribute in a process of attending at least one educational content for the job offerer Y1 is equal to or less than a predetermined value.

The educational content proposal unit 24 generates at least one educational content for the job offerer Y2 for causing the job seeker to add an attribute, based on the attribute gap between the attribute of the job seeker and the request attribute of the job offerer Y2 in the process of attending at least one educational content for the job offerer Y1. Specifically, the educational content proposal unit 24 generates at least one educational content for the job offerer Y2 in such a way as to reduce the attribute gap between the attribute of the job seeker and the request attribute of the job offerer Y2 in the process of attending the at least one educational content for the job offerer Y1. Then, the educational content proposal unit 24 proposes the generated educational content to the job seeker.

A feedback unit 25 proposes, to the job seeker as feedback information, information indicating how the attribute gap between the attribute of the job seeker and the request attribute of the job offerer Y2 changes before and after attendance of at least one educational content for the job offerer Y2.

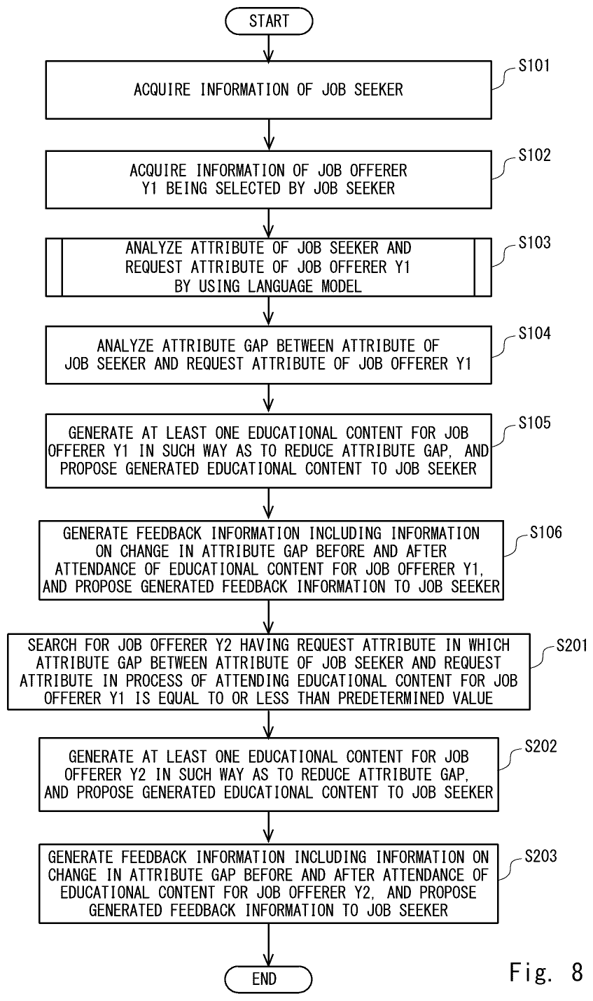

Subsequently, operation of the education support apparatus 30 according to the third example embodiment will be described with reference to FIG. 8. FIG. 8 is a flowchart illustrating one example of the operation of the education support apparatus 30 according to the present example embodiment.

As illustrated in FIG. 8, the education support apparatus 30 executes the processing from step S101 to step S106 described above (see FIG. 3). Thereafter, the education support apparatus 30 performs processing from step S201 to step S203.

First, in step S201, an attribute gap analysis unit 23 searches for the job offerer Y2 having a request attribute in which the attribute gap between an attribute of a job seeker and the request attribute in a process of attending an educational content for the job offerer Y1 is equal to or less than a predetermined value. The request attribute of a job offerer Yn is analyzed from job offering information of the job offerer Yn as in step S103 described above. The job offering information of the job offerer Yn is acquired as in step S102 described above. For example, the job offerer Y2 to be searched has a request attribute in which an attribute gap between the attribute of the job seeker after attendance of educational contents A and B, and the request attribute is equal to or less than a predetermined value.

Next, in step S202, the educational content proposal unit 24 generates at least one educational content for the job offerer Y2 in such a way as to reduce the attribute gap between the attribute of the job seeker and the request attribute of the job offerer Y2 in the process of attending the educational content for the job offerer Y1, and proposes the generated educational content to the job seeker. For example, the educational content proposal unit 24 generates the educational content A, the educational content B, and an educational content G as the educational content for the job offerer Y2. Herein, the educational content G is generated in such a way that there is no attribute gap between the attribute of the job seeker after attendance of the educational content A and B, and the request attribute of the job offerer Y2.

Next, in step S203, the feedback unit 25 provides the job seeker with feedback information including information on a change in the attribute gap before and after attendance of the educational content for the job offerer Y2.

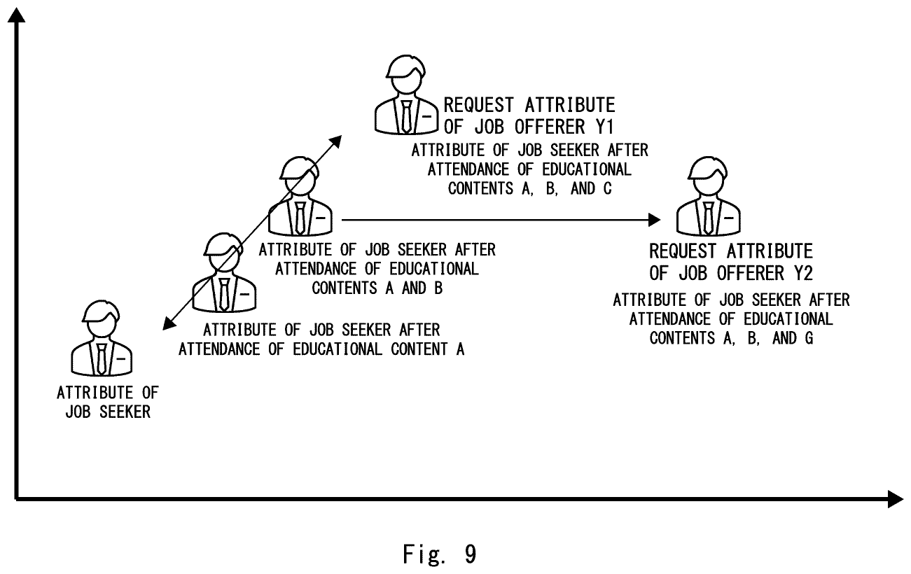

For example, the feedback unit 25 causes a job seeker terminal 100 to display a screen (feedback screen) including the feedback information illustrated in FIG. 9. FIG. 9 is a diagram illustrating one example of a feedback screen displayed on the job seeker terminal 100 by the education support apparatus 30 according to the present example embodiment. As illustrated in FIG. 9, the attribute of the job seeker, the request attribute of the job offerer Y1 being selected by the job seeker, and the attribute gap therebetween are displayed on the feedback screen. Further, on the feedback screen, the attribute of the job seeker after attendance of the educational content A, the attribute of the job seeker after attendance of the educational contents A and B, and the attribute of the job seeker after attendance of the educational contents A, B, and C are displayed (similar to FIG. 7). In addition, on the feedback screen, the request attribute of the newly proposed job offerer Y2 is displayed. Further, the attribute of the job seeker after attendance of the educational contents A, B, and G, which are educational contents for the job offerer Y2, is displayed. Herein, the attribute of the job seeker after attendance of the educational contents A, B, and G matches with the request attribute of the job offerer Y2. From such feedback information, the job seeker can acquire an option of a job offerer being another target. Further, it can be seen that the job seeker can aim at the job offerer Y2 in place of the job offerer Y1 when the job seeker attends the educational content G in place of the educational content C after attendance of the educational contents A and B. Even when the job seeker is targeted at the job offerer Y1, the job seeker can easily change the target according to a situation at that time.

Therefore, the education support apparatus 30 according to the third example embodiment can support education such as to give flexibility to an option of a target of a job seeker being a user.

### Fourth Example Embodiment

Subsequently, a configuration of an education support apparatus 40 according to a fourth example embodiment will be described.

The education support apparatus 40 further includes a configuration for proposing, to a job seeker, a training plan in which a combination of educational contents is optimized for the job seeker. The education support apparatus 40 basically includes a configuration similar to the education support apparatus 20 according to the second example embodiment. However, the following configuration is added to the education support apparatus 40.

An educational content proposal unit 24 of the education support apparatus 40 further generates a training plan of an educational content, and proposes the generated training plan to a job seeker. In the training plan, a combination of educational contents proposed to the job seeker is optimized.

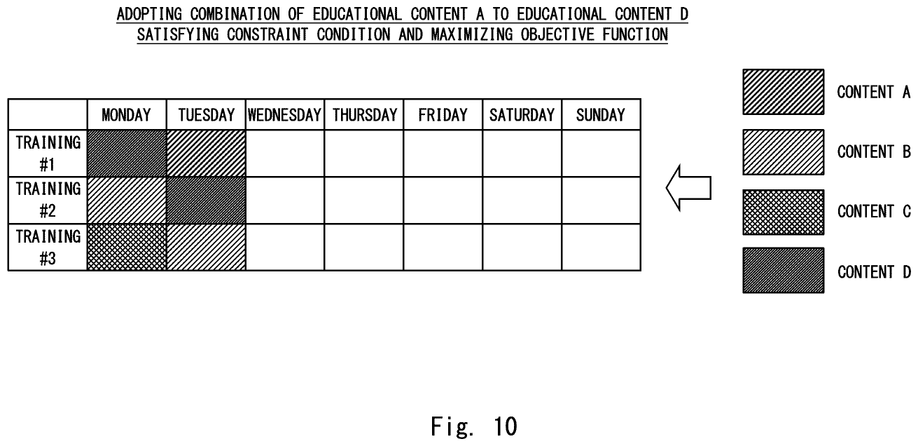

FIG. 10 is a diagram illustrating one example of a training plan proposed by the education support apparatus 40 according to the present example embodiment.

As illustrated in FIG. 10, in the training plan, each of training #1 to training #3 is performed every day from Monday to Sunday. For each training, any of an educational content A to an educational content D is adopted.

In the training plan, a combination of the educational content A to the educational content D satisfying a constraint condition and maximizing an objective function is adopted.

The objective function is calculated as, for example, “objective function=α×(training state)+β×(training style)+ . . . ”. The training state and the training style are for an individual job seeker, and are quantified. In the calculation of the objective function, weighting from past data may be performed by inverse reinforcement learning.

Further, the constraint condition is set, for example, as in the following (1) to (3). (1) Being equal to or greater than a set training time of a day. (2) Staying in a set budget. (3) Over a week, evenly loading an attribute of a job seeker to be desired to add.

The educational content proposal unit 24 optimizes the combination of the educational contents by performing mathematical optimization, based on the objective function and the constraint condition described above.

The education support apparatus 40 according to the fourth example embodiment achieves an advantageous effect similar to the education support apparatus 20 according to the second example embodiment. Moreover, the education support apparatus 40 proposes, to a job seeker, a training plan in which a combination of educational contents is optimized for the job seeker.

Therefore, in the education support apparatus 40, a job seeker can train more effectively.

Note that, the present disclosure is not limited to the above-described example embodiments, and can be appropriately modified without departing from the spirit.

### <Example of Hardware Configuration>

Each functional component unit of the education support apparatus 10, the education support apparatus 20, the education support apparatus 30, and the education support apparatus 40 may be achieved by hardware (e.g., a hardwired electronic circuit, or the like) that achieves each functional component unit, or may be achieved by a combination of hardware and software (e.g., a combination of an electronic circuit and a program that controls the electronic circuit, or the like). Hereinafter, a case where each functional component unit of the above-described apparatus is achieved by a combination of hardware and software will be further described.

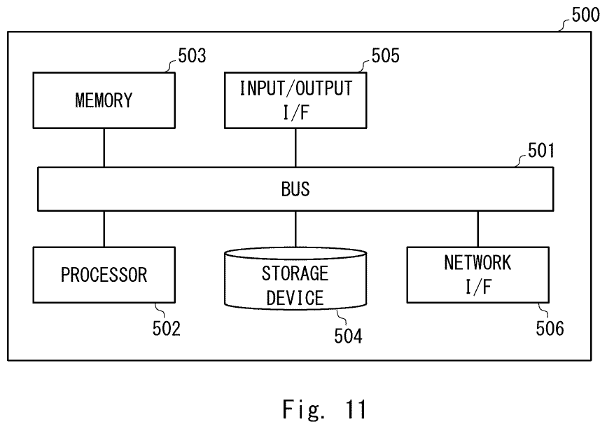

FIG. 11 is a block diagram illustrating one example of a hardware configuration of a computer 500 according to the present example embodiment. Each of the education support apparatus 10, the education support apparatus 20, the education support apparatus 30, and the education support apparatus 40 can be achieved by the computer 500 having a hardware configuration illustrated in FIG. 11. The computer 500 may be a portable computer such as a smart phone or a tablet terminal, or may be a stationary computer such as a personal computer (PC). The computer 500 may be a dedicated computer, or may be a general-purpose computer.

For example, by installing a predetermined application on the computer 500, the computer 500 can have a desired function. By installing an application achieving each function of the apparatus on the computer 500, each function is achieved by the computer 500.

The computer 500 includes a bus 501, a processor 502, a memory 503, a storage device 504, an input/output interface (I/F) 505, and a network interface (I/F) 506. The bus 501 is a data transmission path through which the processor 502, the memory 503, the storage device 504, the input/output interface 505, and the network interface 506 transmit and receive data to and from one another. However, a method of connecting the processors 502 and the like to one another is not limited to bus connection.

The processor 502 is a variety of processors, such as a central processing unit (CPU), a graphics processing unit (GPU), or a field-programmable gate array (FPGA). The memory 503 is a main storage apparatus achieved by using a random access memory (RAM) or the like. The storage device 504 is an auxiliary storage apparatus achieved by using a hard disk, a solid state drive (SSD), a memory card, a read only memory (ROM), or the like.

The input/output interface 505 is an interface for connecting the computer 500 and an input/output device. For example, an input apparatus such as a keyboard, or an output apparatus such as a display apparatus is connected to the input/output interface 505.

The network interface 506 is an interface for connecting the computer 500 to a network. The network may be a local area network (LAN), or may be a wide area network (WAN).

The storage device 504 stores a program for achieving a desired function.

For example, the storage device 504 included in the computer 500 stores a program for achieving each function of the apparatus. The processor 502 achieves each function by reading the program into the memory 503 and executing the read program.

These programs include instructions (or a software code) that, when loaded into a computer, cause the computer to perform one or more of the functions described in the example embodiments. The program can be stored and provided to a computer using any type of non-transitory computer readable media.

Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Some or all of the above-described example embodiments may be described as the following supplementary notes, but are not limited thereto.

### (Supplementary Note 1)

An education support apparatus including:
an acquisition unit configured to acquire information of a user and information of a first target of the user;
an attribute analysis unit configured to analyze an attribute of the user and a request attribute of the first target of the user by using a language model, from the information of the user and the information of the first target of the user;
an attribute gap analysis unit configured to analyze a difference in an attribute between the attribute of the user and the request attribute of the first target of the user; and
an educational content proposal unit configured to generate at least one educational content for the first target for causing the user to add an attribute, based on the difference in the attribute, and propose the generated educational content to the user.

### (Supplementary Note 2)

The education support apparatus according to supplementary note 1, wherein the educational content proposal unit generates at least one educational content for the first target for causing the user to add an attribute in such a way as to reduce a difference in an attribute between the attribute of the user and the request attribute of the first target of the user.

### (Supplementary Note 3)

The education support apparatus according to supplementary note 1, wherein
the user is a job seeker, and
the first target of the user is a job offerer.

### (Supplementary Note 4)

The education support apparatus according to supplementary note 1, further including a feedback proposal unit configured to propose, to the user as feedback information, information indicating how a difference in an attribute between the attribute of the user and the request attribute of the first target of the user changes before and after attendance of at least one educational content for the first target.

### (Supplementary Note 5)

The education support apparatus according to supplementary note 1, wherein
the educational content proposal unit proposes, to the user, a second target being different from the first target of the user and satisfying a predetermined condition, and
the predetermined condition is that the second target has a request attribute in which a difference in an attribute between the attribute of the user and the request attribute in a process of attending at least one educational content for the first target is equal to or less than a predetermined value.

### (Supplementary Note 6)

The education support apparatus according to supplementary note 5, wherein the educational content proposal unit generates at least one educational content for the second target for causing the user to add an attribute, based on a difference in an attribute between the attribute of the user and a request attribute of the second target of the user in a process of attending at least one educational content for the first target, and proposes the generated educational content to the user.

### (Supplementary Note 7)

The education support apparatus according to supplementary note 6, further including a feedback proposal unit configured to propose, to the user as feedback information, information indicating how a difference in an attribute between the attribute of the user and the request attribute of the second target of the user changes before and after attendance of at least one educational content for the second target.

### (Supplementary Note 8)

The education support apparatus according to supplementary note 1, wherein the difference in the attribute is represented by at least one of a cosine similarity degree, a Euclidean distance, and a similarity degree according to a pre-trained language model including BERT.

### (Supplementary Note 9)

An education support method including:
acquiring information of a user and information of a first target of the user;
analyzing an attribute of the user and a request attribute of the first target of the user by using a language model, from the information of the user and the information of the first target of the user;
analyzing a difference in an attribute between the attribute of the user and the request attribute of the first target of the user; and
generating at least one educational content for the first target for causing the user to add an attribute, based on the difference in the attribute, and proposing the generated educational content to the user.

### (Supplementary Note 10)

The education support method according to supplementary note 9, further including generating at least one educational content for the first target for causing the user to add an attribute in such a way as to reduce a difference in an attribute between the attribute of the user and the request attribute of the first target of the user.

### (Supplementary Note 11)

The education support method according to supplementary note 9, wherein
the user is a job seeker, and
the first target of the user is a job offerer.

### (Supplementary Note 12)

The education support method according to supplementary note 9, further including proposing, to the user as feedback information, information indicating how a difference in an attribute between the attribute of the user and the request attribute of the first target of the user changes before and after attendance of at least one educational content for the first target.

### (Supplementary Note 13)

The education support method according to supplementary note 9, further including proposing, to the user, a second target being different from the first target of the user and satisfying a predetermined condition,
wherein the predetermined condition is that the second target has a request attribute in which a difference in an attribute between the attribute of the user and the request attribute in a process of attending at least one educational content for the first target is equal to or less than a predetermined value.

### (Supplementary Note 14)

The education support method according to supplementary note 13, further including generating at least one educational content for the second target for causing the user to add an attribute, based on a difference in an attribute between the attribute of the user and a request attribute of the second target of the user in a process of attending at least one educational content for the first target, and proposing the generated educational content to the user.

### (Supplementary Note 15)

The education support method according to supplementary note 14, further including proposing, to the user as feedback information, information indicating how a difference in an attribute between the attribute of the user and the request attribute of the second target of the user changes before and after attendance of at least one educational content for the second target.

### (Supplementary Note 16)

The education support method according to supplementary note 9, wherein the difference in the attribute is represented by at least one of a cosine similarity degree, a Euclidean distance, and a similarity degree according to a pre-trained language model including BERT.

### (Supplementary Note 17)

A program causing a computer to execute processing of:
acquiring information of a user and information of a first target of the user;
analyzing an attribute of the user and a request attribute of the first target of the user by using a language model, from the information of the user and the information of the first target of the user;
analyzing a difference in an attribute between the attribute of the user and the request attribute of the first target of the user; and
generating at least one educational content for the first target for causing the user to add an attribute, based on the difference in the attribute, and proposing the generated educational content to the user.

### (Supplementary Note 18)

The program according to supplementary note 17, further causing a computer to execute processing of generating at least one educational content for the first target for causing the user to add an attribute in such a way as to reduce a difference in an attribute between the attribute of the user and the request attribute of the first target of the user.

### (Supplementary Note 19)

The program according to supplementary note 17, wherein
the user is a job seeker, and
the first target of the user is a job offerer.

### (Supplementary Note 20)

The program according to supplementary note 17, further causing a computer to execute processing of proposing, to the user as feedback information, information indicating how a difference in an attribute between the attribute of the user and the request attribute of the first target of the user changes before and after attendance of at least one educational content for the first target.

### (Supplementary Note 21)

The program according to supplementary note 17, further causing a computer to execute processing of proposing, to the user, a second target being different from the first target of the user and satisfying a predetermined condition,
wherein the predetermined condition is that the second target has a request attribute in which a difference in an attribute between the attribute of the user and the request attribute in a process of attending at least one educational content for the first target is equal to or less than a predetermined value.

### (Supplementary Note 22)

The program according to supplementary note 21, further causing a computer to execute processing of generating at least one educational content for the second target for causing the user to add an attribute, based on a difference in an attribute between the attribute of the user and a request attribute of the second target of the user in a process of attending at least one educational content for the first target, and proposing the generated educational content to the user.

### (Supplementary Note 23)

The program according to supplementary note 22, further causing a computer to execute processing of proposing, to the user as feedback information, information indicating how a difference in an attribute between the attribute of the user and the request attribute of the second target of the user changes before and after attendance of at least one educational content for the second target.

### (Supplementary Note 24)

The program according to supplementary note 17, wherein the difference in the attribute is represented by at least one of a cosine similarity degree, a Euclidean distance, and a similarity degree according to a pre-trained language model including BERT.

An example advantage according to the above-described example embodiments is to provide an education support apparatus, an education support method, and a program that are capable of supporting education in which an attribute of a user is added in such a way as to satisfy a request attribute of a target of the user.

What is claimed is:

1. An education support apparatus comprising:
at least one memory storing instructions, and
at least one processor configured to execute the instructions to:
acquire information of a user and information of a first target of the user;
analyze an attribute of the user and a request attribute of the first target of the user by using a language model, from the information of the user and the information of the first target of the user;
analyze a difference in an attribute between the attribute of the user and the request attribute of the first target of the user; and
generate at least one educational content for the first target for causing the user to add an attribute, based on the difference in the attribute, and propose the generated educational content to the user.

2. The education support apparatus according to claim 1, wherein the at least one processor is further configured to execute the instructions to generate at least one educational content for the first target for causing the user to add an attribute in such a way as to reduce a difference in an attribute between the attribute of the user and the request attribute of the first target of the user.

3. The education support apparatus according to claim 1, wherein
the user is a job seeker, and
the first target of the user is a job offerer.

4. The education support apparatus according to claim 1, wherein the at least one processor is further configured to execute the instructions to propose, to the user as feedback information, information indicating how a difference in an attribute between the attribute of the user and the request attribute of the first target of the user changes before and after attendance of at least one educational content for the first target.

5. The education support apparatus according to claim 1, wherein
the at least one processor is further configured to execute the instructions to propose, to the user, a second target being different from the first target of the user and satisfying a predetermined condition, and
the predetermined condition is that the second target has a request attribute in which a difference in an attribute between the attribute of the user and the request attribute in a process of attending at least one educational content for the first target is equal to or less than a predetermined value.

6. The education support apparatus according to claim 5, wherein the at least one processor is further configured to execute the instructions to generate at least one educational content for the second target for causing the user to add an attribute, based on a difference in an attribute between the attribute of the user and a request attribute of the second target of the user in a process of attending at least one educational content for the first target, and propose the generated educational content to the user.

7. The education support apparatus according to claim 6, wherein the at least one processor is further configured to execute the instructions to propose, to the user as feedback information, information indicating how a difference in an attribute between the attribute of the user and the request attribute of the second target of the user changes before and after attendance of at least one educational content for the second target.

8. The education support apparatus according to claim 1, wherein the difference in the attribute is represented by at least one of a cosine similarity degree, a Euclidean distance, and a similarity degree according to a pre-trained language model including BERT.

9. An education support method comprising:
acquiring information of a user and information of a first target of the user;
analyzing an attribute of the user and a request attribute of the first target of the user by using a language model, from the information of the user and the information of the first target of the user;
analyzing a difference in an attribute between the attribute of the user and the request attribute of the first target of the user; and
generating at least one educational content for the first target for causing the user to add an attribute, based on the difference in the attribute, and proposing the generated educational content to the user.

10. A non-transitory computer-readable medium storing a program causing a computer to execute processing of:
acquiring information of a user and information of a first target of the user;
analyzing an attribute of the user and a request attribute of the first target of the user by using a language model, from the information of the user and the information of the first target of the user;
analyzing a difference in an attribute between the attribute of the user and the request attribute of the first target of the user; and
generating at least one educational content for the first target for causing the user to add an attribute, based on the difference in the attribute, and proposing the generated educational content to the user.
